(19) United States
(12) Patent Application Publication
(10) Pub. No.: US 2013/0283806 A1
(43) Pub. Date: Oct. 31, 2013

(54) COMBUSTOR AND A METHOD FOR REPAIRING THE COMBUSTOR

(71) Applicants: James Christopher Monaghan, Moore, SC (US); Thomas Edward Johnson, Greer, SC (US); Johnie F. McConnaughhay, Greenville, SC (US); Heath Michael Ostebee, Piedmont, SC (US)

(72) Inventors: James Christopher Monaghan, Moore, SC (US); Thomas Edward Johnson, Greer, SC (US); Johnie F. McConnaughhay, Greenville, SC (US); Heath Michael Ostebee, Piedmont, SC (US)

(73) Assignee: GENERAL ELECTRIC COMPANY, Schenectady, NY (US)

(21) Appl. No.: 13/456,602

(22) Filed: Apr. 26, 2012

(51) Int. Cl. F23R 3/42; B23P 15/00

(52) U.S. Cl. 60/754; 29/890.01

(57) ABSTRACT

A combustor generally includes a liner that at least partially defines a combustion chamber within the combustor. The liner may generally include a hole that extends through the liner and that at least partially defines a mating surface. An insert having an outer surface extends at least partially through the hole. A projection that at least partially defines a mating surface at least partially circumferentially surrounds the insert outer surface. A joint between the projection mating surface and the hole mating surface provides a connection point between the projection mating surface and the liner hole mating surface.

### FIELD OF THE INVENTION

This invention relates generally to gas turbine combustion technology and, more specifically, to a combustion liner and a method for repairing the combustion liner.

### BACKGROUND OF THE INVENTION

Gas turbines typically include a compressor, a combustor downstream from the compressor and a turbine downstream from the combustor. The combustor generally includes a casing that at least partially surrounds several components that define a flow path to direct combustion gases through the combustor and into the turbine. For example, the combustor may include one or more fuel nozzles, a combustion liner that extends downstream from the fuel nozzles and a transition piece that extends downstream from the combustion liner. In operation, a working fluid such as ambient air is compressed as it flows through the compressor. The compressed working fluid flows into the combustor and across an outer surface of the transition piece and the combustion liner to provide convective cooling to those components. At least a portion of the compressed working fluid may flow through one or more dilution holes that extend through the liner. In this manner the compressed working fluid may mix with a fuel within a combustion chamber that is at least partially surrounded by the liner.

Certain combustion liner designs provide an insert that extends through the one or more dilution holes to generally provide structural support to the liner dilution hole. The insert is typically welded to the liner using a fillet weld. However, the extreme temperatures and combustor dynamics within the combustor and in particular, around the combustion liner, may result in cracking and potential failure of the fillet weld joint. As a result, the mechanical life of current combustion liners may be significantly reduced. Therefore, an improved combustion liner sleeve and a method for installing and/or repairing the liner insert to the combustion liner that would improve the mechanical life of the combustion would be useful.

### BRIEF DESCRIPTION OF THE INVENTION

Aspects and advantages of the invention are set forth below in the following description, or may be obvious from the description, or may be learned through practice of the invention.

One embodiment of the present invention is a combustor that includes a liner, a combustion chamber at least partially surrounded by the liner, a hole that extends through the liner and at least partially defines a mating surface, an insert that has an outer surface and that extends at least partially through the hole. The combustor may also include a projection that has a mating surface that at least partially circumferentially surrounds the insert outer surface, and a joint between the projection mating surface and the hole mating surface.

Another embodiment of the present invention is a combustor that includes a liner that at least partially surrounds a combustion chamber, a hole that at least partially defines a mating surface and that extends through the liner, an insert that extends at least partially through the liner hole that includes an outer surface. The combustor may also include a projection that at least partially circumferentially surrounds the insert outer surface and that defines a projection mating surface, a groove in the projection mating surface that at least partially circumferentially surrounds the projection, and a joint between the projection mating surface and the hole mating surface.

The present invention may also include a method for repairing a combustor. The method generally includes removing a first insert from a hole that extends through a liner that is disposed within the combustor, enlarging the diameter of the hole, inserting a second insert having a projection that at least partially circumferentially surrounds an outer surface of the insert. The projection at least partially defines a mating surface. The method also includes joining the projection mating surface to a complementary mating surface defined by the liner hole.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a cross-sectional view of a typical gas turbine combustor;

FIG. 2 is a side elevation view of a combustor liner as shown in FIG. 1;

FIG. 3 is an enlarged top plan view of a portion of the combustion liner as shown in FIG. 2;

FIG. 4 is an enlarged cross-sectional view of a portion of the combustion liner as shown in FIG. 3, according to one embodiment of the present disclosure;

FIG. 5 is an enlarged cross-sectional view of a portion the combustion liner as shown in FIG. 3, according to one embodiment of the present disclosure;

FIG. 6 is an enlarged cross-sectional view of a portion of the combustion liner as shown in FIG. 3, according to one embodiment of the present disclosure;

FIG. 7 is an enlarged cross-sectional view of a portion of the combustion liner as shown in FIG. 3, according to one embodiment of the present disclosure;

FIG. 8 is an enlarged cross-sectional view of a portion of the combustion liner as shown in FIG. 3, according to one embodiment of the present disclosure; and

FIG. 9 is an enlarged cross-sectional view of a portion of the combustion liner as shown in FIG. 3, according to one embodiment of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a combustor having a combustion liner disposed therein. The combustion liner is generally an annular tube that extends radially and axially within at least a portion of the combustor. One or more holes may extend through the combustion liner to allow a working fluid such as compressed air to flow into the combustion liner and into a combustion chamber at least partially defined within the liner. At least some of the one or more dilution holes generally include an insert that extends at least partially through the holes. In particular embodiments, the insert may include a projection that extends at least partially circumferentially around the insert. The projection at least partially defines a projection mating surface that is complementary to a liner hole mating surface. In particular embodiments, a the two complementary surfaces define a butt joint and a butt weld is utilized to connect the projection mating surface and the liner hole mating surface. In alternate embodiments, the projection mating surface may define a groove that at least partially circumferentially surrounds the projection. A braze ring may be inserted into the groove and utilized to connect the projection mating surface and the liner hole mating surface. Although exemplary embodiments of the present invention will be described generally in the context of a combustor incorporated into a gas turbine for purposes of illustration, one of ordinary skill in the art will readily appreciate that embodiments of the present invention may be applied to any combustor and are not limited to a gas turbine combustor unless specifically recited in the claims.

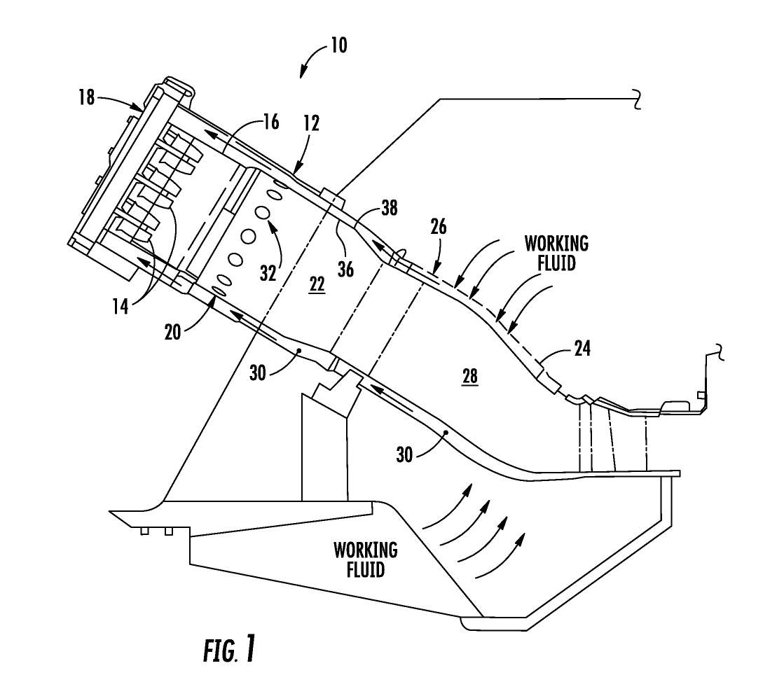

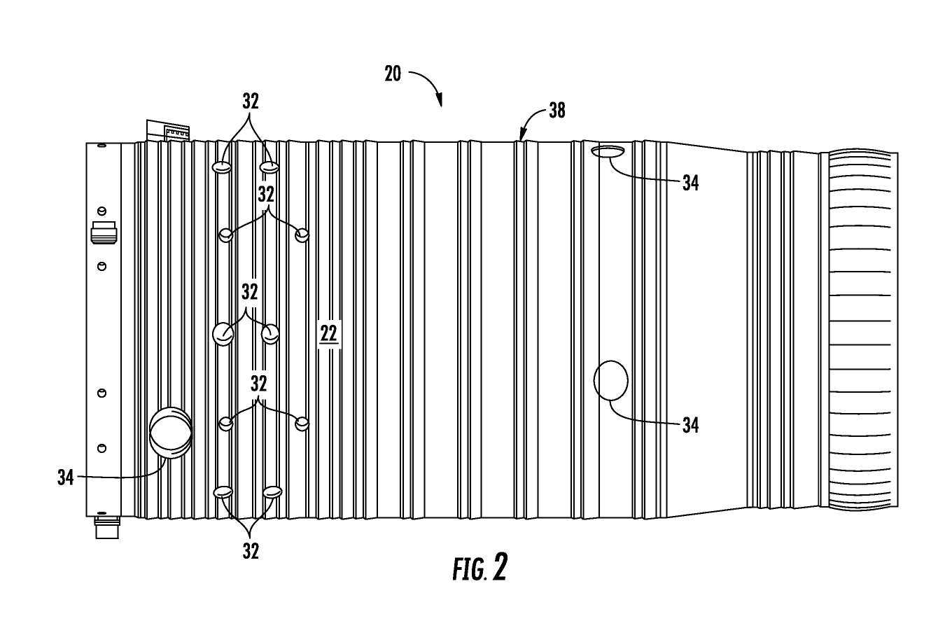

FIG. 1 shows a simplified cross-section view of a combustor 10 according to one embodiment of the present invention. A casing 12 may surround the combustor 10 to contain the air or working fluid flowing to the combustor 10. As shown, the combustor 10 may include one or more nozzles 14 radially arranged in a top cap 16. An end cover 18 and a liner 20 generally surround a combustion chamber 22 located downstream of the nozzles 14. An impingement sleeve 24 with flow holes 26 may surround the transition piece 28 and the liner 20 to define an annular passage 30 between the impingement sleeve 24 and the transition piece 28. The casing 12 may further define the annular passage 30 between the casing and the liner 20. The air or working fluid may pass through the flow holes 26 in the impingement sleeve 24 to flow along the outside of the transition piece 28 and the liner 20 to provide film or convective cooling to the liner 20 and the transition piece 28. The air or working fluid then reverses direction at the end cover 18 to flow through the one or more nozzles 14 where it mixes with fuel before igniting in the combustion chamber 22 to produce combustion gases having a high temperature and pressure. In particular combustor designs, one or more dilution holes 32 extend through the liner 20 to provide fluid communication through the liner 20 and into the combustion chamber 22. As shown in FIG. 2, the liner may also include one or more passages 32 that extend through the liner 20. For example, but not limiting of, the one or more passages 34 may include a cross-fire tube passage, an igniter passage, a camera passage and/or a flame detector passage.

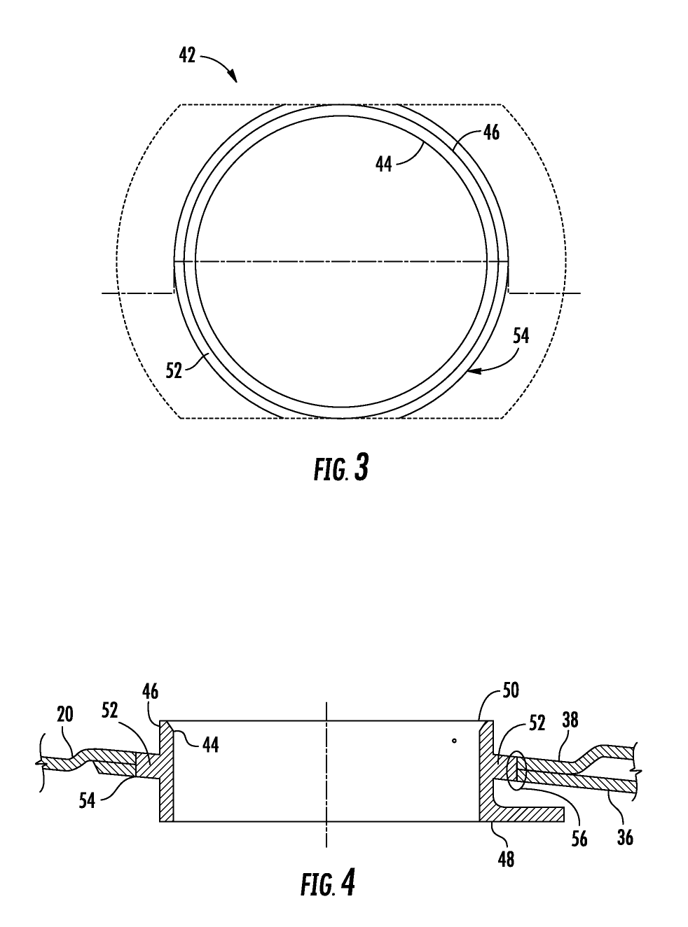

As shown in FIG. 1, the liner 20 generally includes an inner surface 36 and an outer surface 38 radially separated from the inner surface 34. As shown in FIG. 2, the liner 20 outer surface 38 may be generally corrugated or ribbed. In the alternative, the liner 20 outer surface 38 may be generally flat. (not illustrated) The liner 20 may be shaped from one or more continuous sheets of material. In the alternative, the liner 20 may be constructed of multiple overlapping sheets of material. As shown in FIGS. 4-9, the liner may generally define a liner mating surface 40 disposed within the dilution holes 32 and/or the passages 34 that extends radially and/or axially between the liner inner surface 36 as shown in FIG. 1, and the liner outer surface 38 as shown in FIGS. 3-9. The liner 20 may be made from any material designed to withstand the thermal and mechanical stresses found within the combustor 10. In particular embodiments, the liner 20 may be at least partially coated with a heat resistant material such as a thermal barrier coating.

As shown in FIG. 3, at least some of the one or more dilution holes 32 and/or passages 34 may include an insert 42 that extends at least partially through the dilution holes 32 and/or the passages 34. As shown, the insert 42 may be generally annular in shape. However, it should be known by one of ordinary skill in the art that the insert 42 may be of any size or shape that is complementary to the one or more dilution holes 32 and/or the passages 34. As shown in FIGS. 3-9, the insert 42 generally includes an inner surface 44 axially separated from an outer surface 46. As shown in FIGS. 4-9, the insert 42 also includes a bottom end 48 radially separated from a top end 50.

As shown in FIGS. 3-9, a projection 52 extends at least partially circumferentially around the insert outer surface 46. As shown, the projection 52 extends generally axially away from the insert outer surface 46 and extends partially radially between the insert bottom end 48 and the insert top end 50. In particular embodiments, the projection 52 may be welded and/or brazed to the insert outer surface 46. In the alternative, the projection 52 and the insert 42 may be machined from a single piece of material. In this manner, the projection 42 may be said to be integral with the insert.

As shown in FIGS. 4-9, the projection 52 may at least partially define a projection mating surface 54 that at least partially circumferentially surrounds the projection 52. The projection mating surface 54 may be any shape that is complementary to the liner mating surface 40. In particular embodiments, as shown in FIGS. 4-6, the projection mating surface 54 may be shaped so as to provide a butt joint 56 between the liner mating surface 40 and the projection mating surface 54. For example, but not limiting of, as shown in FIG. 4, the liner mating surface 40 and the projection mating surface 54 may be generally parallel. In alternate embodiments, the liner mating surface 40 and the projection mating surface 54 may be chamfered. For example, as shown in FIG. 5, the liner mating surface 40 may diverge radially outward through the dilution hole 32 from the liner inner surface 36, and the projection mating surface 54 may diverge radially outward complementary to the liner mating surface 40.

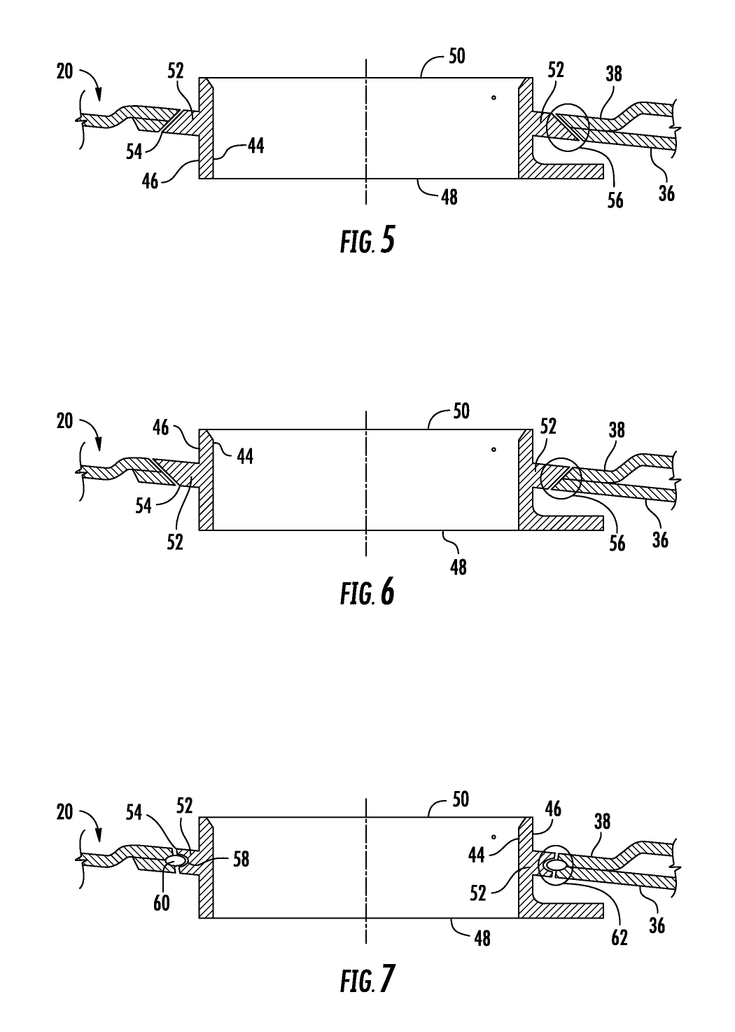

In further embodiments, as shown in FIG. 6, the liner mating surface 40 may converge inward through the dilution hole 32 and/or the passages 34 from the liner inner surface 36 to the liner outer surface 38, and the projection mating surface 54 may diverge inward complementary to the liner mating surface 40. In each of the embodiments disclosed above, a butt weld may join the insert 42 to the liner 20, thereby allowing for a full penetration weld between the liner mating surface 40 and the projection mating surface 54. As a result, the probability of cracking the joint during operation of the combustor 10 may be reduced, thus resulting in increased mechanical life of the liner and/or the combustor.

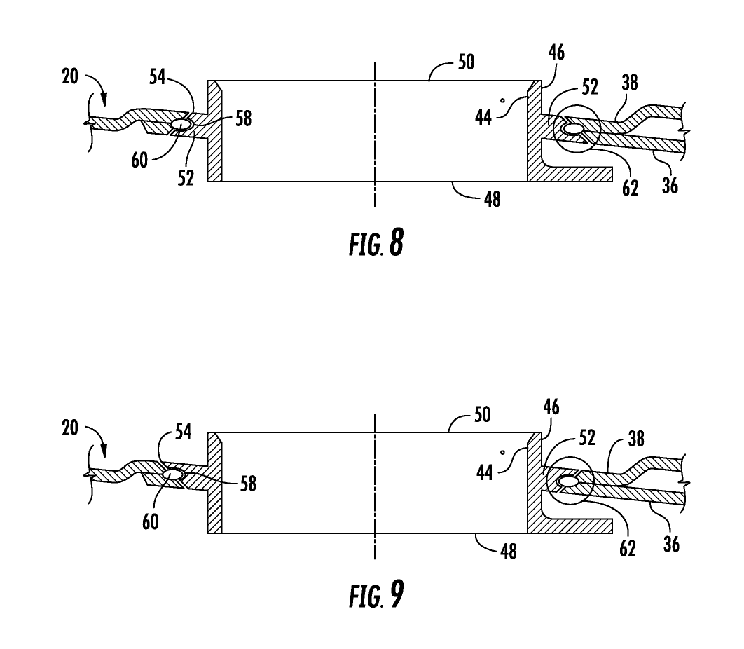

In alternate embodiments, as shown in FIGS. 7-9, the projection 52 may at least partially define a groove 58 that extends at least partially circumferentially around the projection mating surface 54. The groove 58 may be of any depth and/or width. In particular embodiments, a braze ring 60 may be inserted into the groove 58. In particular embodiments, as shown in FIGS. 7-9, the liner mating surface 40 and the projection mating surface 54 may be shaped so as to provide a butt joint 56 between the liner mating surface 40 and the projection mating surface 54. For example, as shown in FIG. 7, the liner mating surface 40 and the projection mating surface 54 may be generally parallel. In alternate embodiments, the liner mating surface 40 and the projection mating surface 54 may be chamfered. For example, as shown in FIG. 8, the liner mating surface 40 may diverge inward from the liner inner surface 3 towards the liner outer surface 36, and the projection mating surface 54 may diverge complementary to the liner mating surface 40. In further embodiments, as shown in FIG. 9, the liner mating surface 40 may converge from the liner inner surface 34 towards the liner outer surface 36, and the projection mating surface 54 may converge complementary to the liner mating surface 40. In each of the embodiments as shown in FIGS. 7-9, a brazed butt joint 62 may connect the projection mating surface 40 to the liner mating surface 54, thereby allowing for a full penetration joint between the liner mating surface 40 and the projection mating surface 54. As a result, the probability of cracking the joint during operation of the combustor may be reduced, thus resulting in increased mechanical life of the liner.

The various embodiments shown and described with respect to FIGS. 4-9 may also provide a method for repairing the combustor 10. The method may include removing a first insert 42 from at least one of the one or more dilution holes 32 and/or the one or more passages 34, enlarging the diameter of the dilution hole 32 and/or the passages 34, inserting a second insert 42 that includes the projection 52 and the projection mating surface 54, and joining the projection mating surface 54 to a complementary liner mating surface 40 so as to provide a butt joint 56 therebetween. The method may further include butt welding the projection mating surface 54 to the complementary liner mating surface 40. In further embodiments, the method may include inserting the braze ring 60 into the groove 58 at least partially defined in the projection 52 and brazing the projection mating surface 54 to the complementary liner mating surface 40. The method may also include chamfering the liner 20 dilution hole 32. For example, the method may include chamfering the liner 20 dilution hole 32 radially outward from the liner inner surface 36. The method may further include chamfering the liner 20 dilution hole 32 radially inward from the liner inner surface 36. FIGS. 4-9 may also provide a method for assembling the combustor 10. The method may include inserting the insert 42 that includes the projection 52 and the projection mating surface 54 into the liner 20 dilution hole 32 and/or into at least one of passages 34 and joining the projection mating surface 54 to a complementary liner mating surface 40 so as to provide a butt joint 56 therebetween.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A combustor comprising:
a. a liner;
b. a combustion chamber at least partially surrounded by the liner;
c. a hole that extends through the liner, the hole having a mating surface;
d. an insert having an outer surface, the insert extends at least partially through the hole;
e. a projection having a mating surface, the projection at least partially circumferentially surrounds the insert outer surface; and
f. a joint between the projection mating surface and the hole mating surface.

2. The combustor as in claim 1, wherein the liner hole is a dilution hole.

3. The combustor as in claim 1, wherein the projection is integral to the insert.

4. The combustor as in claims 1, wherein the joint between the projection mating surface and the hole mating surface is a butt joint.

5. The combustor as in claim 1, wherein the liner hole mating surface diverges radially outward from an inner surface of the liner to an outer surface of the line.

6. The combustor as in claim 1, wherein the liner hole mating surface converges radially inward from an inner surface of the liner to an outer surface of the liner.

7. The combustor as in claim 1, wherein the projection mating surface is angled complementary to the liner hole mating surface.

8. A combustor comprising:
a. a liner;
b. a combustion chamber at least partially surrounded by the liner;
c. a hole that extends through the liner, the hole having a mating surface;
d. an insert having an outer surface, the insert extends at least partially through the hole;
e. a projection defining a mating surface, the projection at least partially circumferentially surrounds the insert outer surface;
f. a groove in the projection mating surface that at least partially circumferentially surrounds the projection; and
g. a joint between the projection mating surface and the hole mating surface.

9. The combustor as in claim 8, further comprising a braze ring disposed within the projection groove.

10. The combustor as in claim 8, wherein the projection is integral to the insert.

11. The combustor as in claim 8, wherein the joint includes a butt joint.

12. The combustor as in claim 8, wherein the liner hole mating surface diverges inward from an inner surface of the liner to an outer surface of the liner.

13. The combustor as in claim 8, wherein the liner hole mating surface converges inward from an inner surface of the liner to an outer surface of the liner.

14. The combustor as in claim 8, wherein the projection mating surface is angled complementary to the liner hole mating surface.

15. The combustor as in claim 8, wherein the hole is a dilution hole.

16. A method for assembling a combustor, comprising:
a. removing a first insert from a hole that extends through a liner disposed within the combustor;
b. enlarging the diameter of the hole;
c. inserting a second insert having a projection, the projection having a mating surface, wherein the projection at least partially circumferentially surrounds an outer surface of the insert; and
d. joining the projection mating surface to a complementary liner hole mating surface.

17. The method as in claim 15, further comprising butt welding the projection mating surface to the complementary mating surface defined by the liner hole.

18. The method as in claim 15, further comprising inserting a braze ring into a groove defined within the projection mating surface and brazing the projection mating surface to the complementary liner hole mating surface.

19. The method as in claim 15, further comprising chamfering the liner hole mating surface, wherein the chamfer diverges radially outward from an inner surface of the liner to an outer surface of the liner.

20. The method as in claim 15, further comprising chamfering the liner hole mating surface, wherein the chamfer converges radially inward from an inner surface of the liner to an outer surface of the liner.
